(19) United States
(12) Patent Application Publication
(10) Pub. No.: US 2007/0107055 A1
(43) Pub. Date: May 10, 2007

(54) Data virus protection

(76) Inventor: Hans Olof Dagborn, Taby (SE)

Correspondence Address: Hans Dagborn, Grastensvagen 9, Taby, 18734, SE

(21) Appl. No.: 11/285,784

(22) Filed: Nov. 23, 2005

(30) Foreign Application Priority Data
Nov. 9, 2005 (SE) 0502473-2

(51) Int. Cl. G06F 12/14

(52) U.S. Cl. 726/22

(57) ABSTRACT

The invention relates to a virus protection and a computerized equipment (10) utilizing the protection. Every executable data file (32) is provided unique by adding an electronic signature in the end of every file (44), which is generated with a computer program/algorithm (28) for that purpose, with a predetermined number of bits. It comprises that no data files (32) without signature are admitted execution in the computer. A key (30) is individually generated in every computerized equipment (10), utilized by the algorithm (28) to create the unique signature (44) for every single data file (32), by utilizing the contents of the data files (42).

### TECHNICAL FIELD

The present invention pertains to virus protection for equipment in computers comprising execution of computer data files and computer equipment.

### BACKGROUND ART

For instance the problem with the Internet today is that attacks from computer viruses are a serious problem and it is also a growing one. There exists a wide variety of virus protection programs, whereby the present inventor utilizes a virus protection program from Panda Software®. This program, as well as other known programs, utilizes a method that comprises identifying a virus and the infected files by searching after “virus signatures”, i.e., the significant part of a virus. The inventor's present virus protection program has been loaded with 83440 different signatures. To generate these signatures a virus first has to be discovered and analyzed. Then the virus signature has to be identified. It is possible that the virus can alter it self. This means that the producers of viruses always are one step a head, just like a medical virus, which affects living creatures.

Furthermore, a side-effect sometimes can occur that affects a program that isn't infected with a virus but by coincidence contains a code sequence, which is identical with the virus signature, this also happened to the inventor with a program developed in its whole on a computer that never had been connected to the internet and only contained secure software. On this computer the program functioned well, but on a computer supplied with virus protection it couldn't start. Attempts to utilize the program only resulted in a virus message on the computer screen.

The Document EP 0768594 A1 illustrates a system with a hierarchic memory structure, which prevents a virus from executing in the top level of the memory in a memory hierarchy. A label is utilized for labelling of an area of the memory in which a specific program may be run.

Patent application document EP 0886202 A2 illustrates a method intended to control a programs authenticity. This is provided through the method of giving a program access to data outside of the program. A control of a programs digital signature is also achieved.

U.S. Pat. No. 5,289,540 A illustrates a system with a hierarchic file structure to protect the security of data files. No access of the security system can be made through the operative system. A control of every files digital signature, before it is run, is achieved.

In U.S. Pat. No. 6,351,816 B1, a method of handling security when running a program by calculating and applying a digital signature is illustrated. A run is achieved in a so called “sandbox”, i.e., a restricted part of the memory where an unknown/untested program is allowed to run.

Problems mentioned are solved with the present inventions virus protection.

### SUMMARY OF THE INVENTION

There exist possibilities to in a safe way prevent unknown programs from sabotaging computerized equipment with a processor/CPU in a network according to the present invention. Every executable file is provided uniquely by adding an electronic signature in the end of the file comprising a predetermined number of bits. To achieve the mentioned the present invention sets forth a virus protection for equipment comprising computers for execution of data files. Every executable data file is provided uniquely by adding an electronic signature at the end of every file, which is generated by a computer program for that purpose, with a predetermined number of bits. This comprises:

that no data files without a signature are admitted into the computer;

a generating algorithm software, which the computer program utilizes to generate a signature;

a key that is generated individually for computerized equipments, utilized by the generating algorithm to create a unique signature for every individual data file by utilizing the contents of the data files, whereby the generating algorithm software is only provided useful through commands from the keyboard, and utilized by the computer user for input of commands, by starting of a program in a data file it is controlled that the signature is correct.

In one embodiment the computerized equipment is run by a memory manager with at least three management levels, these consists of one supervisory level segment, one code level segment and one data level segment which comprises:

that the supervisory level segment comprises a program with supervisory status and I/O-management for the computerized equipment, the supervisory level segment inhibiting unauthorized programs in the data files to operate in the file managers file managing;

the code level segment comprises programs having no supervisory level status, thus only a program with supervisory status is admitted to write a code level segment, but all the programs in the computerized equipment can read from this segment; and

that the data level segment comprises all the data files in which all level segments data can be written and read, wherein the memory manager prevents the contents in the data level segment to be executed as a program, and in which software in the data files that enter the computer from external units first run through the data level segment to be stored in a hard drive, whereby a computer user manually generates an approved signature for software having generating algorithm software, wherein software in the data file with the unique signature is downloadable in the code level segment.

A further embodiment comprises that the same program in a different computerized equipment is having another signature due to that they have different keys that operate on the data file.

Furthermore, the present invention sets forth a computerized equipment with virus protection comprising a processor for execution of data files. Every executable data file provided uniquely by adding an electronic signature in the end of every file, that is generated with a computer program for that purpose, with a predetermined number of bits which comprises:

that no data files without a signature are admitted into the computer;

generating algorithm software, which the computer program utilizes to generate a signature;

a key that is generated individually for computerized equipments, utilized by the generating algorithm to create a unique signature for every individual data file by utilizing the contents of the data files, whereby the generation algorithm software is only provided useful through commands from the keyboard, and utilized by the computer user for input of commands, by starting of a program in a data file it is controlled that the signature is correct.

The attached dependent claims to the computerized equipment state that the embodiments correspond with the virus protection according to the above.

### BRIEF DESCRIPTION OF THE DRAWING

Henceforth reference is had to the attached drawings in the following text for a better understanding of given examples and embodiments, wherein:

FIG. 1 schematically illustrates a computer equipment with virus protection according to the present invention; and

FIG. 2 schematically illustrates a data file that is processed to obtain a virus protection according to the present invention.

### DETAILED DESCRIPTION OF PREFERRED EMBODIMENTS

In accordance with the present invention the possibility exists to in a secure way stop an external program from sabotaging a computer in a network or computerized equipment. Every executable data file is provided uniquely by adding an electronic signature in the end of every file comprising, for example, 128 bits. The signature is generated with a specific program. A Cryptographic algorithm, which this program utilizes, does not need to be secret. The key however must be secret and should be generated individually for every computer in connection with the installation of the operative system on a completely “clean” disk. The signature is generated with the utilization of the key and the content of the program files. Hereby in principle there does not exist two identical installations of one and the same program. At pre start of a program the signature is checked for correctness. If it is correct, only then will the program start. This makes it possible to prevent an external program from executing in a computer. The program that generates signatures should be available by a command form the keyboard or the like. This is to definitively prevent unwanted generation of correct signatures. The above described is secure only if it is protected by a “Memory Management Unit” also named below as MM or memory manager. The demand on the Memory Management, MM, is that it should have at least three levels (or segments): Supervisor, Code and Data.

A supervisory level segment comprises all programs that have supervisory status as well as all the I/O-management. Thereby preventing all unauthorized programs from being executed in the file manager. It is namely important that no unauthorized program can change name or erase or rewrite the supervisory level segment program. It is of course inappropriate that the file manager or the program that generates the signature should be affected unauthorized. Furthermore the key must be utilized to keep generation of signatures secret. As well as the control of MM only should be provided for programs in the segment.

In the code level segment there exist only programs, that don't have supervisory status. Only supervisory programs can write in this segment.

In the data level segment all the changeable data is found. MM should prevent the contents in the data level segment from being executed. In this segment it is only allowed to read and write. When a program is received from the internet, it is downloaded in the data level segment. It is then saved on a hard drive. The operator/user then manually generates a valid signature for the computer equipment.

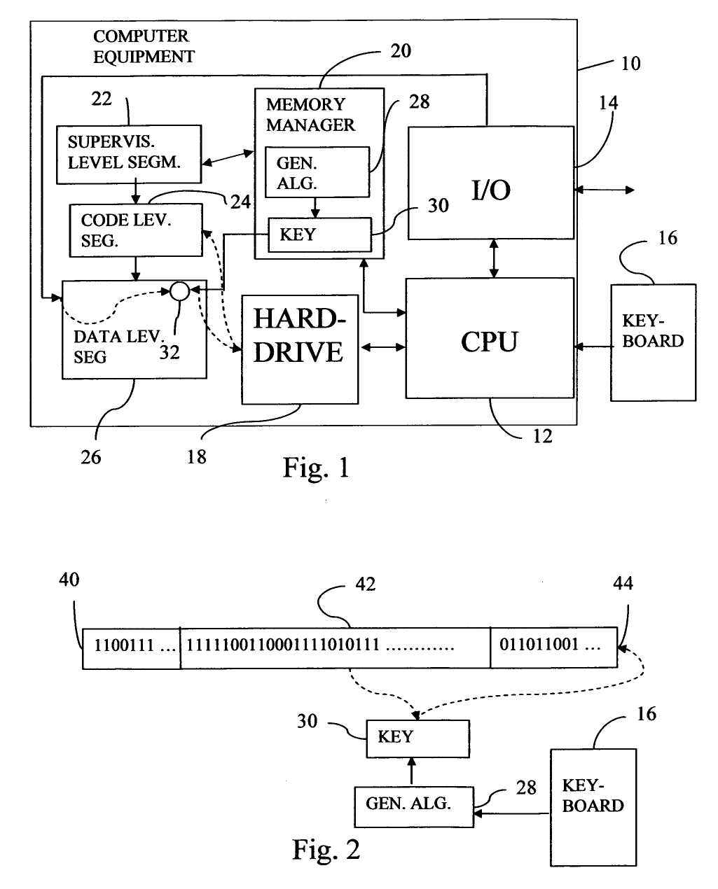

FIG. 1 schematically illustrates computer equipment 10 with a virus protection according to the present invention. Computer equipment can be any equipment with a processor 12 connected to a memory unit (not specifically shown in FIG. 1) and which interacts with the external through an I/O-unit 14 that processes computer programs and/or data files like a PC, mobile phone, PDA, laptop and similar equipment. Henceforth, computer equipment 10 is handled according to FIG. 1 as a PC with CPU 12, I/O-unit 14, keyboard 16, hard drive 18. The arrows in FIG. 1 illustrate an embodiment of possible communication paths in the PC 10.

To provide a virus protection according to the present invention there is a memory manager 20 implemented in the hard drive. The memory manager 20 runs a supervisory level segment 22 that is connected to a code level segment 24, which in turn is connected with a data level segment 26. The generation algorithm 28 operates with a code key 30 that is unique to each single computer equipment.

The memory manager runs a generation algorithm 28 for the production of unique codes that should be utilized for virus protection of data files. The generation algorithm 28 and key is activated through the keyboard 16 so that every new data file 32 which should be coded gets the code initiated manually.

In FIG. 1 a new data file 32, schematically marked as a circle in the figure, has arrived to the PC 10 by an I/O-port 14. A data file 32 in accordance with the following description can comprise for example executable software and/or other data that usally is saved in a data file 32. Every executable data file 32 is provided uniquely by adding an electronic signature in the end of every file 32, which is generated by a computer program for that purpose, with a predetermined number of bits. The virus protection according to the present invention is as mentioned run by a memory manager 20 with three handling levels, these consist of one supervisory level segment 22, one code level segment 24 and one data level segment 26.

This comprises that a supervisory level segment 22 contains programs with supervisory status and I/O-handling for the computer, wherein the supervisory level segment 22 prevents unauthorized programs from being executed in a file managers file manager or in programming of the memory manager.

The code level segment 24 comprises programs that do not have supervisory status, wherein only programs with supervisory status is admitted to write in the code level segment 24, but all programs in the computer can read from this segment 24.

Data level segment 26 comprises all data files in which all level segments can both write and read. The memory manager 20 prevents the content in the data level segment 26 from being executed as a program. Software that enters the computer as a data file 32 from external units first end up in the data level segment 26 so that it subsequently can be stored in a hard drive 18, whereby the computer user manually generates a valid signature for the software/data file 32 with the generation algorithm software 28. The software/data file 32 with the unique signature can then be downloaded in the code level segment 24. The data files 32 path in the PC when it is virus protected is illustrated by the broken line arrows in FIG. 1. No data files 32 that lack signatures are allowed execution in the PC 10.

FIG. 2 schematically illustrates a data file 32 that is processed to obtain a virus protection according to the present invention. The data file comprises an embodiment of a data head 40, data and/or software 42 and signature 44 that virus protects the data file 32. There exists a generation algorithm software/algorithm 28, which computer software utilizes to generate the signature 44. Furthermore, a key 30 is provided, which is individually generated for every computer and is stored for utilization by the generation algorithm 28 to create the unique signature 44 for every separate data file 32 with utilization of the data files contents 42, wherein the generation algorithm software 28 is only provided useful through commands on the keyboard 16, utilized by the computer user for entering of commands. At pre start of a program the signature is checked 44 for correctness. This leads to that the same program/data file 32 in another computer will have a different signature 44 because they have different keys 30. The broken lines in FIG. 2 schematically illustrate how the signature 44 is provided and added to the data file 32 per se.

Programs that exist in the supervisory level segment can read and write in all the segments. No other program can read and write in the supervisory level segment.

Programs in the code level segment can read the contents in the code level segment as well as read and write in the data segment. There is only data in the data segment. No programs that exist here can be executed. Without contribution from an operator/user of the PC 10 no unauthorized programs can be stored as authorized and scripts can not fool a interpretator so that for instance a stack overflow, with execution of “data”, as a consequence, something that sometimes occurs in current computers.

The present invention is not in first hand referred to limit the consequences of what a program, that utilizes scripts, can accomplish, except from stopping I/O-access directly and generation of valid signatures to program files. To prevent uncontrolled spamming of e-mail the mail program can be modified so that a dispatch must be initiated from an operator console.

Discipline is demanded of an operator, so that he/she does not generate valid signatures to unknown, possible infected programs. If the operator should make a mistake only his/hers computer would be inflicted, the virus will not be accepted by other computers.

The present invention is completely backward compatible with the current Internet. All changes, which have to be accomplished, are completely local. The PC 10 becomes immune against viruses whereby it does not either send possible received viruses further on to the Internet.

The cost to implement the present invention is limited to modifications of the operative system and possible modifications of the MMU (Memory Management Unit).

The present invention as it has been described through examples and embodiments, but not limited to these, whereby the attached claims describe further embodiments to a person skilled in the art in the present technical field.

1. A virus protection for an apparatus comprising computerized equipment (10) for execution of data files (32), Characterized in that every executable data file (32) is provided uniquely by adding an electronic signature in the end of every file (44), which is generated with a computer program for that purpose, with a predetermined number of bits comprising:
that no data files (32) without a signature (44) are admitted into the computer (10);
generating algorithm software (28), which the computer program utilizes to generate a signature (44);
a key (30) that is generated individually for computerized equipments (10), utilized by the generating algorithm (28) to create a unique signature (44) for every individual data file (32) by utilizing the contents of the data files (42), whereby the generation algorithm software (28) is only provided useful through commands from the keyboard (16), and utilized by the computer user for input of commands, by starting of a program in a data file (32) it is controlled that the signature (44) is correct.

2. A virus protection according to claim 1, characterized by the computerized equipment (10) run by a memory manager (20) with at least three management levels, these levels being one supervisory level segment (22), one code level segment (24) and one data level segment (26) comprising:
that the supervisory level segment (22) comprises a program with supervisory status and I/O-management for the computerized equipment (10), said supervisory level segment (22) inhibiting unauthorized programs in the data files (32) to operate in the file managers file managing;
the Code level segment (24) comprises programs having no supervisory level status, thus only a program with supervisory status is admitted to write in a code level segment (24), but all the programs in the computerized equipment (10) can read from this segment; and
that the data level segment (26) comprises all the data files (32) in which all level segments data can be written and read, wherein the memory manager (20) prevents the contents in the data level segment (26) to be executed as a program, and in which software in the data files (32) that enter the computer (10) from external units first run through the data level segment (26) to be stored in a hard drive (18), whereby a computer user manually generates an approved signature (44) for software having generating algorithm software (28), wherein software in the data file (32) with the unique signature is downloadable in the code level segment (24).

3. A virus protection according to anyone of claims 1 or 2, characterized in that the same program in different computerized equipment is having another signature (44) due to having different keys (30) that operate on the data file (32).

4. Computerized equipment (10) with virus protection comprising a processor (12) for execution of data files (32), Characterized in that every executable data file (32) is provided uniquely by adding an electronic signature in the end of every file (44), which is generated with a computer program for that purpose, with a predetermined number of bits comprising:
that no data files (32) without a signature (44) are admitted into the computer (10);
generating algorithm software (28), which the computer program utilizes to generate a signature (44);
a key (30) that is generated individually for computerized equipments (10), utilized by the generating algorithm (28) to create a unique signature (44) for every individual data file (32) by utilizing the contents of the data files (42), whereby the generation algorithm software (28) is only provided useful through commands from the keyboard (16), and utilized by the computer user for input of commands, by starting of a program in a data file (32) it is controlled that the signature (44) is correct.

5. Computerizing equipment (10) according to claim 4, characterized in that it is run by a memory manager (20) with at least three management levels, these levels being one supervisory level segment (22), one code level segment (24) and one data level segment (26) comprising:
that the supervisory level segment (22) comprises a program with supervisory status and I/O-management for the computerized equipment (10), said supervisory level segment (22) inhibiting unauthorized programs in the data files (32) to operate in the file managers file managing;
the code level segment (24) comprises programs having no supervisory level status, thus only a program with supervisory status is admitted to write in a code level segment (24), but all the programs in the computerized equipment (10) can read from this segment; and
that the data level segment (26) comprises all the data files (32) in which all level segments data can be written and read, wherein the memory manager (20) prevents the contents in the data level segment (26) to be executed as a program, and in which software in the data files (32) that enter the computer (10) from external units first run through the data level segment (26) to be stored in a hard drive (18), whereby a computer user manually generates an approved signature (44) for software having generating algorithm software (28), wherein software in the data file (32) with the unique signature is downloadable in the code level segment (24).

6. Computerized equipment according to anyone of claims 4 or 5, characterized in that the same program in different computerized equipment is having another signature (44) due to having different keys (30) that operate on the data file (32).
